(19) United States
(12) Patent Application Publication
(10) Pub. No.: US 2002/0152071 A1
(43) Pub. Date: Oct. 17, 2002

(54) Human-augmented, automatic speech recognition engine

(76) Inventors: David Chaiken, Menlo Park, CA (US); Mark J. Foster, Palo Alto, CA (US)

Correspondence Address: GLENN PATENT GROUP, 3475 EDISON WAY, SUITE L, MENLO PARK, CA, 94025, US

(21) Appl. No.: 09/834,852

(22) Filed: Apr. 12, 2001

(51) Int. Cl. G10L 15/04

(52) U.S. Cl. 704/251

(57) ABSTRACT

A system and method combines the advantages of automatic speech recognition and human-to-human conversation in a speech recognition engine. Human intervention is used to augment an automatic speech recognition engine. When a confidence metric is low enough, the system transmits an utterance to a human operator. The human then transcribes the text, which is then provided back to the automatic system. In the preferred embodiment, no real time human-to-human conversation ever actually takes place. Thus, the user experience is consistent with automatic, machine speech recognition. A mechanism is also provided for examining voice recognition statistics that are gathered over many users. If there is a high correction rate for a particular word or phrase, the system automatically directs words that are in a potential match list to a human transcriber and makes no independent effort to recognize such words. The speech system learns from such human transcription and improves its speech recognition models or grammar over time, based upon the input from human transcription.

### BACKGROUND OF THE INVENTION

1. Technical Field

The invention relates to voice recognition systems. More particularly, the invention relates to a human-augmented, automatic speech recognition engine.

2. Description of the Prior Art

Machine speech recognition is a vexing problem. There are systems that are used instead of speech recognition by recording samples and then play such recordings to humans at a later time, e.g. directory assistance systems. In these systems, the humans are the speech recognition engine. There are also systems that use computers for speech recognition and then bail out completely to human-to-human conversation. In other words, the machines give up entirely when they cannot perform satisfactory speech recognition. For example, airline reservations systems use pre-canned, human-written responses for questions that are asked on the Web.

It would be desirable to provide a system and method that combines the advantages of automatic speech recognition and human-to-human conversation in a speech recognition engine.

### SUMMARY OF THE INVENTION

The present invention provides a system and method that combines the advantages of automatic speech recognition and human-to-human communication in a speech recognition engine. The presently preferred embodiment of the invention uses human intervention to augment an automatic speech recognition engine. When a confidence metric is low enough, the system transmits an utterance to a human operator. The human then transcribes the text, which is then provided back to the automatic system. In the preferred embodiment, no real time human-to-human conversation ever actually takes place. Thus, the user experience is consistent with automatic, machine speech recognition.

The preferred embodiment of the invention also provides a mechanism for examining voice recognition statistics that are gathered over many users. If there is a high correction rate for a particular word or phrase, e.g. El Salvador earthquake, the system automatically directs words that include, for example El Salvador, in the potential match list to a human transcriber and initially makes no independent effort to recognize such words. In this way, system latency is significantly improved because the speech recognition engine does not engage in a time consuming and fruitless attempt to recognize such words.

Over time, the speech system learns from such human transcription and improves its speech recognition models or grammar, based upon the input from human transcription. The presently preferred mechanism for learning is similar to, and may be based upon, existing voice model training systems, but relies upon third party input, i.e. that of the human transcriber, as opposed to that of an actual user. In this sense, the invention also provides a mechanism that performs automatic speech training.

### BRIEF DESCRIPTION OF THE DRAWINGS

FIG. 1 is a block schematic diagram that shows a human augmented, automatic speech recognition system according to the invention.

### DETAILED DESCRIPTION OF THE INVENTION

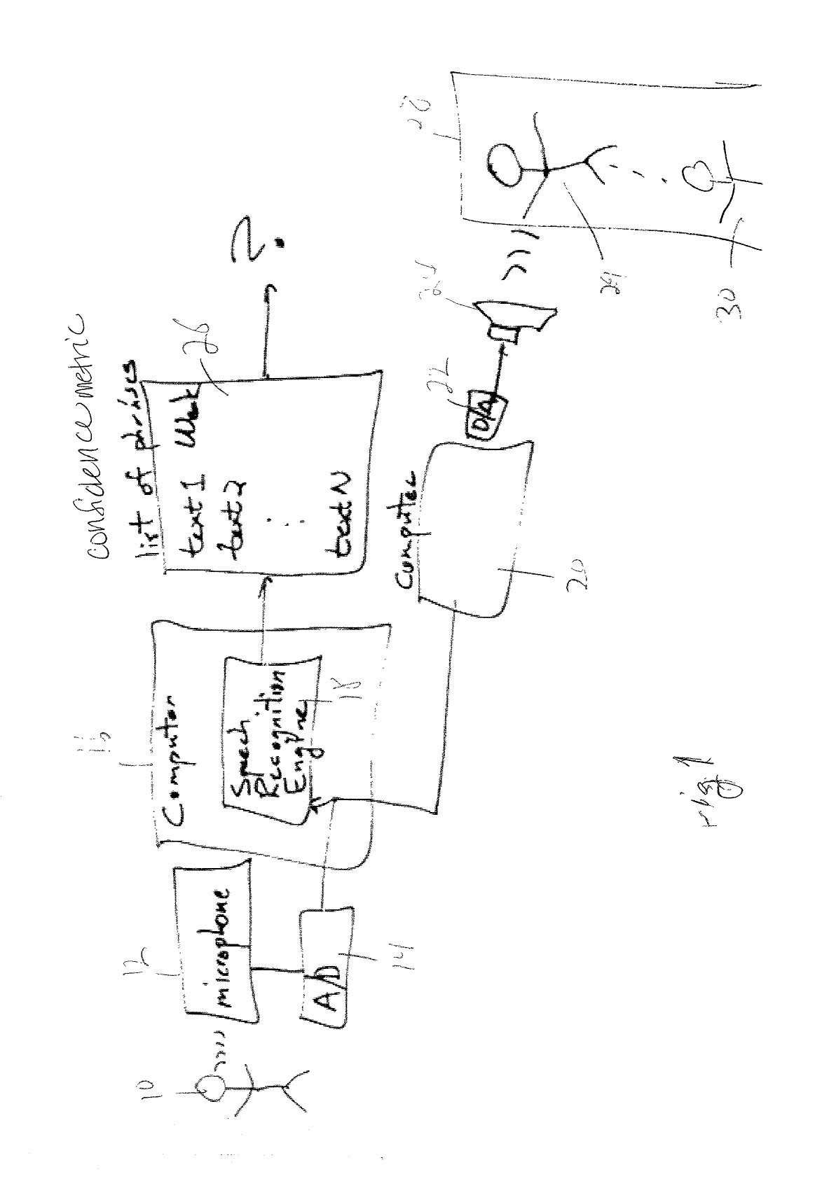

FIG. 1 is a block schematic diagram that shows a human augmented, automatic speech recognition system according to the invention. The presently preferred embodiment of the invention uses human intervention 28 to augment an automatic speech recognition engine 18. When a confidence metric 26 is low enough, the system transmits an utterance to a human operator. The human then transcribes the text, which is then provided back to the automatic system, e.g. via a computer 20. In the preferred embodiment, no real time human-to-human conversation needs to take place. Thus, the user experience is consistent with automatic, machine speech recognition.

The preferred embodiment of the invention also provides a mechanism, such as a computer 16 for examining voice recognition statistics that are gathered over many users. If there is a high correction rate for a particular word or phrase, e.g. El Salvador earthquake, the system automatically directs words that include, for example El Salvador, in the potential match list to a human transcriber and makes no independent effort to recognize such words. In this way, system latency is significantly improved because the speech recognition engine does not engage in a time consuming and fruitless attempt to recognize such words.

Over time, the speech system learns from such human transcription and improves its speech recognition models or grammar, based upon the input from human transcription. The presently preferred mechanism for learning is similar to, and may be based upon, existing voice model training systems, but relies upon third party input, i.e. that of the human transcriber, as opposed to that of an actual user. In this sense, the invention also provides a mechanism that performs automatic speech training.

In the long run, human feedback as provided in the herein disclosed invention is thought to be critical to the accuracy and success of a dynamic grammar system. For example, the human feedback is readily provided to handle relatively uncommon words that suddenly increase in popularity. This functionality allows the system to adapt quickly, for example to changing television program names in a voice television navigation system, hot news topics, hot entertainment topics, and similar sorts of information.

FIG. 1 shows a computer 16 that includes a speech recognition engine 18. At the input to the system, there is a person 10 who is speaking into a microphone 12. The microphone is in communication with an analogue-to-digital (A/D) converter 14. The A/D converter samples the speech input via the microphone, and the system provides a digitized signal to the speech recognition engine. The speech recognition engine can be plugged directly into a computer such that the digitized speech is processed at the same location as that of the person who is speaking, or speech samples (or a digitized signal derived therefrom) can be routed from the location of the person who is pseaking over a network to a remotely located speech recognition engine.

In the presently preferred embodiment of the invention, the microphone is associated with a voice controlled television navigation system, which operates in conjunction with a set-top box. Spoken commands from a user are digitized at the set top box, or simply routed in analog form, over a hybrid fiber coax network into an speech recognition engine, such as the AgileTV system, developed by AgileTV of Menlo Park, Calif. (see, for example, [inventor, title], U.S. patent applicant Ser. No., ______ filed, attorney docket no. [AGLE0001] and [inventor, title], U.S. patent applicant serial no., ______ filed, attorney docket no. [AGLE0003].

The speech recognition engine is cued to look at these speech samples and recognize the user's commands. The commands, once recognized, are executed. For example. the user may have instructed the system to buy a pay-per-view movie. Once this command is recognized, the action is readily executed.

The speech recognition engine, in practice, tends to produce a list of potential phrases plus confidence readings for these phrases 26, which are actually text strings, e.g. text string one, text string two, and so forth. In the best case, the speech recognition engine identifies a phrase that has a very high confidence rating or an extremely high confidence rating, so that the rest of the system can strongly believe that it knows what the person has said. The invention herein is primarily concerned with what happens if the speech recognition engine does not know what the person has said, if there is a very weak confidence, or if any number of phrases have been identified as potentially matching what the person said.

A key aspect of the invention is that if the speech recognition engine fails to recognize a person's command and comes out with a question mark, then the same speech samples are routed through the system, e.g. via a computer 20 having a digital-to-analog (D/A) converter 22, to an amplifier and speaker 24, and then to a human being 29, 30. While the prior art provides true speech recognition systems and provides human operated systems, the invention provides a novel, hybrid system where speech is first routed through a speech recognition system, and if that fails then it is routed to a human operator.

The invention preferably provides a bank 28 of a relatively small number of human recognizers 29, 30. Among the human recognizers, there may be people who are facile with different languages and can redirect unrecognized speech through a speech recognition system for such languages. For example, a system in California may be used by people who are Spanish speakers. In such setting, the invention contemplates that there would be human recognizers who are Spanish speakers. Thus, if the speech recognition engine does not understand what a person said, then the speech is routed to a human recognizer who would immediately understand that the speech is not English, but Spanish. The human recognizer then can redirect the speech to someone who speaks Spanish or they could instruct the speech recognition engine to use a Spanish speech recognition dictionary. The invention also provides a mechanism that remembers that a particular person speaks Spanish. Thus, in future sessions, that person would be interpreted by a speech recognition engine that is applying a Spanish dictionary.

Another aspect of the invention provides feedback from the human recognizers to the speech recognition engine. For example, suppose people are cruising the Web and suddenly everybody in the world starts saying “Joe Isuzu.” Nobody in twelve years had said Joe Isuzu, but suddenly, he's on the front page of the business section and ads are cropping up that feature him. So everybody's going to start saying, “Joe Isuzu” again. The invention provides a speech recognition system that adapts to things that suddenly become part of the culture again because the human recognizer can get back to the speech recognition engine and say, “That word is Joe Isuzu.” If that happens enough times, then the speech recognition engine can, with time, build the capability to handle this phrase without human intervention.

An important element of the invention is that it continues to get better vis-a-vis such aspects of language as culture elements and language elements, et cetera. Thus, the invention contemplates an offline element in which a human performs a speech recognition task, for example where a sufficiently bandwidth system to makes such human assistance appear to be an online operation. Such aspect of the invention is alternatively interactive in that real time human intervention is used to train the speech recognition engine. Thus, feedback from human recognizers may be provided either as an offline operation as a batch input based upon collected human interventions, or an online operation as the intervention is provided.

In the presently preferred embodiment of the invention, there are three ways in which feedback can be applied from the human recognizer. There is the direct method of direct translation; there is a secondary method of targeting alternate recognizers; and there is a third method of optimizing grammars. All three are unique and could be applied in any one of those throughways.

As an example of the first way in which feedback can be supplied, consider that the human recognizer hears the word “kartoffel.” So the human recognizer says, “This was nonsense and means nothing.” Or, perhaps the word kartoffel means something in German, in which case the human recognizer would provide a response in German. Thus, such recognition is a direct, “I got it/I didn't get it” type in the textual translation process that returns a result to the speech recognition engine, to be executed.

The second way in which feedback can be supplied recognizes that, e.g. kartoffel, was German. In this case, the system provides a hint to the speech recognition engine, specifically the household parameter block associated with this person. Then, in future recognition sentences the system can run a German recognition path so that in an automated matter in the future the speech recognition engine can catch mixed potentially English and German utterances based upon the individual associated with the household parameter block, e.g. the system sets an alternate language flag for that individual. That is, the system knows either to check the German dictionary as well as the English dictionary, or to check the German dictionary exclusively.

If a human recognizer who receives a phrase to interpret does not understand a word or phrase, they can forward it to yet another person who is a language expert. This provides a form of screening and assures that the more language proficient and expensive human recognizers are more fully occupied with appropriate recognition tasks. For example, there may be 100 people who are responding and doing recognition and one person who speaks twelve different languages. These people do not have to be in the same building or in the same room. They can be sitting at an office doing another job. When it is specifically needed, they can get an instant message on their screen: “We need you now.” In this way, the invention avoids having skilled people sitting around, e.g. people who are experts in Tagalong, waiting for a Tagalong phrase to come along.

The third way in which feedback is applied is when there is a transitional state in daily communication. It then becomes worthwhile to invest the resources to add a new term to the speech recognition engine, which term previously did not exist, for automatic recognition. This approach actually modifies the speech grammars to take the sounds that comprise the new term and to translate that out into a corresponding text string for that term.

Another embodiment of the invention may be used when a human recognizer understands that he is hearing a different language, but cannot tell which other language it is, although they can tell that they are hearing intelligible human sounds. In this embodiment, the human recognizer directs the system to provide feedback to the person who is speaking, e.g. asking the speaker to state in English what language they are speaking. Once this information is available, an appropriate dictionary, if available, or human recognizer can be used to complete the speech recognition process. Alternatively, the human recognizer can instruct the speech recognition engine to test the utterance against all available language dictionaries, e.g. try all languages.

Another embodiment of the invention links a human recognizer directly to the user interface, thereby providing the human recognizer with the ability to display text back to the person who is speaking on that person's screen. This approach provides a form of ongoing conversation between the person speaking and the human recognizer, although there would be no real time conversation in the commonly understood sense.

In another embodiment of the invention, the system provides a tree of options, where one of the options is if it is not possible to resolve the speech, then the human recognizer is connected directly to the person who is speaking. This approach provides real time voice interaction. This embodiment provides a voice-directed customer service system, in which the person speaking could be requesting immediate real time assistance and the system could recognize such request and route it appropriately. This embodiment can be thought of as a telephone inside a television.

Although the invention is described herein with reference to the preferred embodiment, one skilled in the art will readily appreciate that other applications may be substituted for those set forth herein without departing from the spirit and scope of the present invention. Accordingly, the invention should only be limited by the claims included below.

1. A speech recognition system, comprising:
an automatic speech recognition engine;
a module in communication with said speech recognition engine for determining a confidence metric with regard to an utterance presented to said speech recognition engine, and for transmitting said utterance to a human operator for recognition and transcription when said confidence metric is below a predetermined threshold; and
a mechanism for providing said human transcription of said utterance back to said speech recognition engine.

2. The system of claim 1, further comprising:
a mechanism for gathering speech recognition statistics over many system users and for examining said voice recognition statistics;
wherein, if there is a high correction rate for a particular word or phrase, said speech recognition engine automatically directs words in a potential match list for said word or phrase to a human transcriber and makes no independent effort to recognize such words.

3. The system of claim 1, wherein said speech recognition engine learns from human transcription and improves its speech recognition models or grammar, based upon the input from human transcription.

4. The system of claim 1, wherein human feedback is provided to handle relatively uncommon words that suddenly increase in popularity.

5. The system of claim 1, wherein said speech recognition engine is cued to look at speech samples and recognize a user's commands, wherein said commands, once recognized, are executed.

6. The system of claim 1, wherein said speech recognition engine produces a list of potential phrases plus confidence readings for said phrases.

7. The system of claim 1, further comprising:
a bank of human recognizers.

8. The system of claim 7, wherein among said human recognizers there are people who are facile with different languages and can recognize said languages and redirect unrecognized speech through a speech recognition engine for such languages.

9. The system of claim 8, wherein once a language is human recognized for a particular person, said speech recognition engine remembers that said person speaks said language and applies a dictionary for that language.

10. The system of claim 1, wherein said speech recognition engine receives feedback from said human recognizers, wherein said speech recognition engine, with time, builds capability to handle phrases without human intervention.

11. The system of claim 1, wherein real time human intervention is used by said human transcription mechanism to train said speech recognition engine.

12. The system of claim 1, wherein feedback is directly applied by said human transcription mechanism to said speech recognition engine.

13. The system of claim 1, wherein alternate recognizers are targeted by said human transcription mechanism.

14. The system of claim 1, wherein grammars are optimized by said human transcription mechanism.

15. The system of claim 13, wherein said human transcription mechanism provides a hint to said speech recognition engine to be stored in a household parameter block associated with a person whose speech is being recognized.

16. The system of claim 1, wherein said human recognizer directs said system to provide feedback to a person who is speaking.

17. The system of claim 1, wherein said human transcription mechanism connects a human recognizer directly to a user interface, thereby providing said human recognizer with the ability to display text back to a person who is speaking.

18. The system of claim 1, wherein if it is not possible to resolve speech, then said human transcription mechanism directs a human recognizer directly to a person who is speaking to provide real time voice interaction.

19. A speech recognition method, comprising the steps of:
providing an automatic speech recognition engine;
determining a confidence metric with regard to an utterance presented to said speech recognition engine;
transmitting said utterance to a human operator for recognition and transcription when said confidence metric is below a predetermined threshold; and
providing said human transcription of said utterance back to said speech recognition engine.

20. The method of claim 19, further comprising the steps of:
gathering speech recognition statistics over many system users and for examining said voice recognition statistics;
wherein, if there is a high correction rate for a particular word or phrase, said speech recognition engine automatically directs words in a potential match list for said word or phrase to a human transcriber and makes no independent effort to recognize such words.

21. The method of claim 19, wherein said speech recognition engine learns from human transcription and improves its speech recognition models or grammar, based upon the input from said transcription.

22. The method of claim 19 wherein human feedback is provided to handle relatively uncommon words that suddenly increase in popularity.

23. The method of claim 19, wherein said speech recognition engine is cued to look at speech samples and recognize a user's commands, wherein said commands, once recognized, are executed.

24. The method of claim 19, wherein said speech recognition engine produces a list of potential phrases plus confidence readings for said phrases, wherein said phrases are text strings.

25. The method of claim 19, further comprising the step of:
providing a bank of human recognizers, wherein said bank may be either centrally located or distributed.

26. The method of claim 25, wherein among said human recognizers there are people who are facile with different languages and can recognize said languages and redirect unrecognized speech through a speech recognition engine for such languages.

27. The method of claim 26, wherein once a language is human recognized for a particular person, said speech recognition engine remembers that said person speaks said language and applies a dictionary for that language.

28. The method of claim 19, wherein said speech recognition engine receives feedback from said human recognizers, wherein said speech recognition engine, with time, builds capability to handle phrases without human intervention.

29. The method of claim 19, wherein real time human intervention is used to train said speech recognition engine.

30. The method of claim 19, wherein feedback is directly applied to said speech recognition engine.

31. The method of claim 19, wherein alternate recognizers are targeted by a human transcription mechanism.

32. The method of claim 19, wherein grammars are optimized by a human transcription mechanism.

33. The method of claim 31, wherein said human transcription mechanism provides a hint to said speech recognition engine in the form of a household parameter block associated with a person whose speech is being recognized.

34. The method of claim 19, wherein said human recognizer directs said system to provide feedback to a person who is speaking.

35. The method of claim 19, wherein a human transcription mechanism links a human recognizer directly to a user interface, thereby providing said human recognizer with the ability to display text back to a person who is speaking.

36. The method of claim 19, wherein if it is not possible to resolve speech, then a human transcription mechanism connects a human recognizer directly to a person who is speaking to provide real time voice interaction.
